(19) United States
(12) Patent Application Publication
(10) Pub. No.: US 2008/0167947 A1
(43) Pub. Date: Jul. 10, 2008

(54) CONSUMER GENERATED MEDIA CONTENT

(75) Inventors: Jon Skinner, East Sydney (AU); Christian Finucane, Paddington (AU)

Correspondence Address: SNELL & WILMER LLP (OC), 600 ANTON BOULEVARD, SUITE 1400, COSTA MESA, CA, 92626, US

(73) Assignee: SUPERVIRALS PTY LTD, Surry Hills (AU)

(21) Appl. No.: 11/970,332

(22) Filed: Jan. 7, 2008

(30) Foreign Application Priority Data
Jan. 8, 2007 (AU) 2007900051

(51) Int. Cl. G06Q 30/00

(52) U.S. Cl. 705/10; 705/14

(57) ABSTRACT

This invention relates to consumer-generated media content. A first display area displays a marketing brand and a downcounter to show the time remaining for users to upload media items relating to the displayed brand. The first display area may also show the prize on offer and the brief that users should follow for that brand's competition. A gateway receives uploaded media items, from identified users, and which may display selected identified users' ideas related to an identified brand. A memory stores uploaded items and a processor accessible by an administrator to approve items for display in the second display area, or reject items. A second display area displays one or more uploaded and approved media items, each together with the respective brand, a downcounter to show the time remaining for access to that media item, and a score which may be derived from the number of times visitors have already accessed, voted for or commented about that media item. In particular the invention concerns an Internet web-site for displaying consumer generated media content related to a brand. In another aspect it concerns a method for creating consumer generated media content related to a brand.

### TECHNICAL FIELD

This invention relates to consumer-generated media content, particularly when related to a brand. In a first aspect it concerns an Internet web-site for displaying consumer generated media content related to a brand. In another aspect it concerns a method for creating consumer generated media content related to a brand.

### BACKGROUND ART

Advertisements are ubiquitous on the Internet. There are many sites that provide opportunities to display paid banner type advertisements, and there is much interest in selecting advertisements that are targeted to the particular user. However, as consumers become more sophisticated they are more difficult to reach and to engage.

Internet users within the 12-35 year old demographic group generally demonstrate a preference for community based Internet sites that allow them to post original content. They dislike seeing irrelevant advertising plastered in or around the user-generated content in these sites.

### DISCLOSURE OF THE INVENTION

The invention is an Internet web-site for displaying consumer generated media content related to a brand, comprising:
A first display area to display a marketing brand and a downcounter to show the time remaining for users to upload media items relating to the displayed brand. The media items may be generated in the context of a competition related to the brand, and the first display area may show the prize on offer and the brief that users should follow for that brand's competition.
A gateway to receive uploaded media items, from identified users, and which may display selected identified users' ideas related to an identified brand.
A memory to store uploaded items and a processor accessible by an administrator to approve items for display in the second display area, or reject items.
And, a second display area to display one or more uploaded and approved media items, each together with the respective brand, a downcounter to show the time remaining for access to that media item, and a score which may be derived from the number of times visitors have already accessed, voted for or commented about that media item.

The invention operates to provide consumer-generated brand relevant entertainment by providing an opportunity for users to create material related to a brand. As a result the invention establishes a new way of engaging consumers with brands.

The media items may be audio, image, video or any combination of these media.

The first display area may display an active button that can be activated via a web browser to link to a page where users can upload a media item relating to the displayed brand.

The administrator may be the website administrators or someone representing the participating brand, or a panel.

The second display area may display a frame which visitors click to access the media item. The second display may also display information about the user who uploaded the media item, a title and a description.

Multiple media items for different brands may be displayed in the second display area at any given time. Typically the downcounters of the separate media items will not be synchronised, so the visible media items will expire and be changed at different times.

In any event all the downcounters for media items relating to the same brand will start counting from the same value, so all the media items relating to that brand will have the same maximum period of time during which they can be accessed.

The website may operate to prevent a visitor accessing a media item more than once; or may operate not to count any access by the same visitor after the first. Alternatively, the website may operate not to count any access to a media item by the same visitor within a period of time. A visitor who accesses a media item may enter a vote or comment for it.

The prize may be awarded to the user who uploads the media item having the highest score for a particular brand. The score may be derived from a number of factors, including the number of votes it has received, the number of times the material has been accessed and the number of comments it has received. The prize may be in the form of public recognition for the user, the media item or the number of visitors. Alternatively it may take a tangible form such as a material or cash reward. The reward may be provided by the brand owner.

In a further aspect the invention is a method for creating consumer-generated media content related to a brand, comprising the steps of:
Displaying a marketing brand, the prize on offer, a brief and a downcounter to show the time remaining for visitors to upload media items relating to the brand;
Receiving uploaded media items, from identified users, containing respective users' original ideas related to an identified brand; and
Approving which uploaded media items go forward into the live public phase of the competition.

Displaying one or more uploaded and approved media items, each together with its respective brand, a downcounter to show the time remaining for viewing, and a score for that media item.

The Internet website facilitates brand engagement with consumers by using traffic driven to it via a mass notification of the brand's existing customer email database. It also hosts multiple user-generated content competitions for non-competing brands concurrently, and so provides each brand the increased media benefit of combined incoming traffic and consumer engagement.

### BRIEF DESCRIPTION OF THE DRAWINGS

An example of the invention will now be described with reference to the accompanying drawings, in which:

FIG. 1 is a block diagram of the invention.

FIG. 2 is a screenshot of an Internet site operating the invention.

### BEST MODES OF THE INVENTION

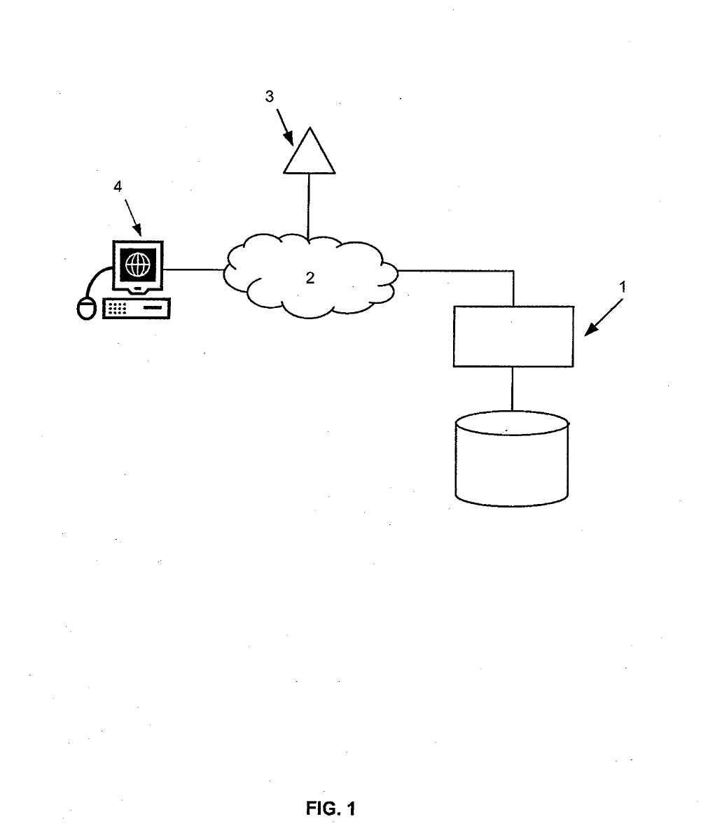

Referring first to FIG. 1, a web server indicated generally at 1 presents a website to the Internet 2. Advertisers 3 are able to pay to have their brand presented on the website. The website 1 is also available to general visitors 4 who may view the site and upload content.

In particular, the advertisers pay to have their brand exhibited for a set time period. During a first part of that time period visitors to the site are invited to create material in their choice of media incorporating or otherwise related to the brand. A simple brief is made available at the site to guide those who respond to the invitation. Once material has been created it the creator can upload it via a gateway at the site for approval. In order to do this the creator is required to provide information that identifies them.

The advertisers have access to a ‘client only’ area on the site where they are able to give final approval for uploaded media items before they get posted live.

Once approved for public display, an uploaded and approved media item related to the brand is made available for visitors to access during the remainder of the time period.

During the remainder of the time period, the popularity of the media item is determined by factors including, but not limited to, the number of votes it has received by website visitors, the number of times the material has been accessed and the number of comments it has received. The creator of the most popular material is rewarded with a competition prize.

Generally, before a prize can be awarded, the creator's identity and address are checked, and any voting or scoring irregularities are investigated.

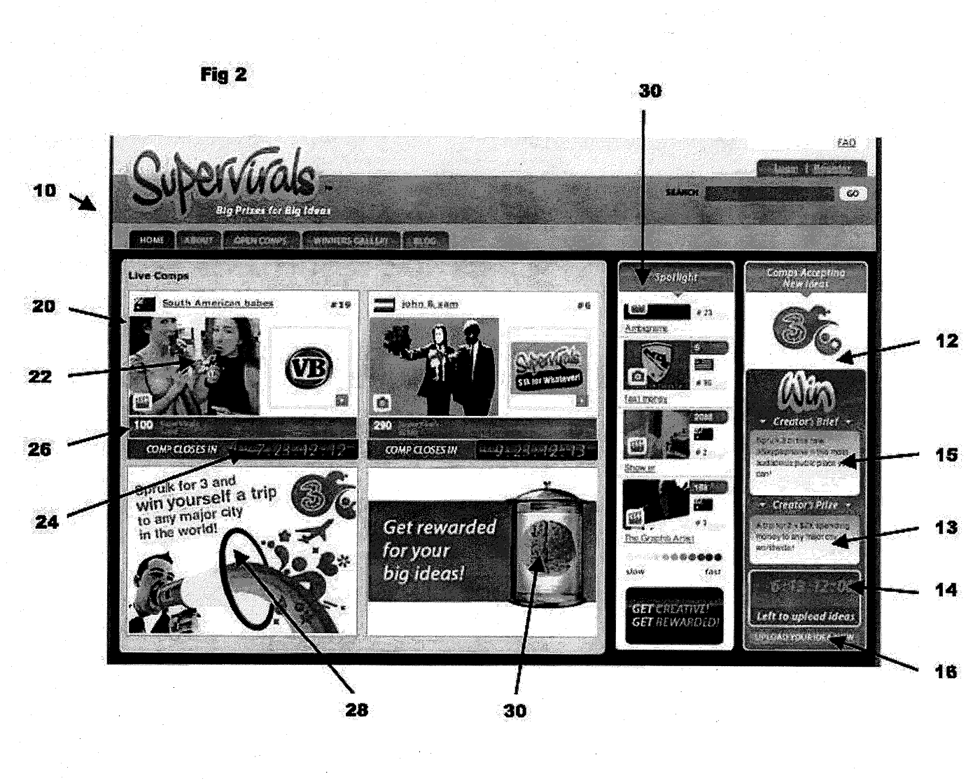

Referring now to FIG. 2 the Internet website 10 available to visitors has a range of different panels and frames, as well as tabs along to the top for navigation around the site.

A first display area is panel 12, which shows the current brand in this case 3 mobile™, for which visitors can choose to create material before it goes ‘live’. The prize on offer is identified at 13. The downcounter 14 at the bottom of the panel shows the time remaining for creators to upload any material they create. The brief to potential creators is available at 15. The material may include words, audio, images or video; in any combination.

An active button is included in the panel at 16 to for creators to upload material in relation to this brand.

A second display area is panel 20, where there are multiple large frames illustrating uploaded material for ‘live’ brands previously displayed in panel 12. In the example VBT frame there is a key frame 22 that operates, when clicked, to take the visitor to a viewing page where the entire uploaded material is displayed.

The downcounter at bottom right 24 indicates the time remaining for accessing this material; in this case the time remaining is seven days, twenty-three hours, twelve minutes and 12 seconds. This time is also the time during which scoring factors such as votes, click-throughs and comment posts are counted for this material. Visitors who like the material may be expected to share their experience with others, for instance by emailing details including an Internet address link to the material to their friends.

Each time a scoring factor occurs for material the counter at 26 is incremented once or more times; in this case there is a score of 100 that represents the combined score from all the scoring factors the material has received. So for instance, each access may score ‘1’, a vote could be ‘5’ and a comment ‘10’.

When the live competition time for accessing the material has expired, that is when downcounter 24 reaches 00:00:00:00 then the material is withdrawn from further scoring, but its last score from counter 26 is recorded. The material with the highest score for that branded offering is then awarded a prize following a manual check confirming the creator's identity, location and checking any voting or scoring irregularities.

Panel 30 shows a vertically scrolling ‘Spotlight’ selection of material. This may be previous prize-winners or other material selected by the website administrators. Although the invention has been described with reference to a particular example, it should be appreciated that it could be exemplified in many other forms and in combination with other features not mentioned above. For instance, it will be appreciated that the downcounters 24 in the four frames of panel 20 will generally show different times remaining; since they will have gone live at different times. And, the counters 26 will be different since they will depend on the number of click-throughs.

Also, when the frames within the second display area are not being utilised for live brand competitions they may be replaced with other promotional panels, as seen at 28 and 30 on FIG. 2. These panels may link to other areas of the website or other websites.

1. An Internet website for displaying consumer generated media content related to a brand, comprising:
a first display area to display a marketing brand and a downcounter to show the time remaining for users to upload media items relating to the displayed brand;
a gateway to receive uploaded media items, from identified users, containing respective identified users' ideas related to an identified brand;
a memory to store uploaded items and a processor accessible by an administrator to approve items for display in the second display area, or reject items;
and, a second display area to display one or more uploaded and approved media items, each together with its respective brand, a downcounter to show the time remaining for access to that media item, and a score for the item.

2. An Internet website according to claim 1, wherein the media item includes audio.

3. An Internet website according to claim 1 or 2, wherein the media item includes one or more images.

4. An Internet website according to claim 1, 2 or 3, wherein the media item includes video.

5. An Internet website according claim 1, wherein the first display area displays an active button that can be activated by an identified user via a web browser to cause upload of a media item relating to the displayed brand.

6. An Internet website according to claim 1, wherein the second display area displays a frame which visitors click to access the media item.

7. An Internet website according to claim 6, wherein the second display area also displays information about the user who uploaded to media item, a title and a description.

8. An Internet website according to claim 1, wherein the media items are generated in the context of a competition related to the brand.

9. An Internet website according to claim 8, wherein the unloaded media items are awarded a score related to factors including the number of votes it has received, the number of times the material has been accessed and the number of comments it has received.

10. An Internet website according to claim 9, wherein the prize is awarded to the user who uploads the media item achieving the highest score for that brand.

11. A method for creating consumer-generated media content related to a brand, comprising the steps of:
displaying a marketing brand and a downcounter to show the time remaining for visitors to upload media items relating to the brand;
receiving uploaded media items, from identified users, containing respective users' original ideas related to an identified brand;
approving which uploaded media items go forward into the live public phase of the competition; and,
displaying one or more uploaded media items, each together with its respective brand, a downcounter to show the time remaining for viewing, and a score for that media item.
